(19) United States
(12) Patent Application Publication
(10) Pub. No.: US 2021/0276727 A1
(43) Pub. Date: Sep. 9, 2021

(54) METHOD AND SYSTEM FOR AUTOMATED ALERTING AND SEQUENCING OF TASKS BASED ON REAL-TIME AIRPLANE CONFIGURATION FEED

(71) Applicant: The Boeing Company, Chicago, IL (US)

(72) Inventor: Mulugheta Abraham, Renton, WA (US)

(21) Appl. No.: 16/813,351

(22) Filed: Mar. 9, 2020

(51) Int. Cl. B64D 45/00; G06F 16/9035; G06F 9/38

(52) U.S. Cl. CPC B64D 45/00; B64D 2045/0085; G06F 9/3838; G06F 16/9035

(57) ABSTRACT

A method includes receiving, by a computer, and via a communication interface of an aircraft, current configuration information associated with the aircraft. The aircraft includes application logic configured to monitor a state associated with each of a plurality of components of the aircraft and to generate the current configuration information. The method includes locating a particular maintenance task record that specifies configuration requirements that match the current configuration information of the aircraft. The configuration requirements specify components of the aircraft and the state within which each of the components should be in to facilitate the performance of a maintenance task associated with the particular maintenance task record. Task information associated with the maintenance task record can be communicated to a maintenance terminal. The task information specifies the configuration requirements and the state of the one or more components specified in the configuration requirements.

### BACKGROUND

### Field

This application generally relates to system maintenance communications. In particular, this application describes a method and system for automated alerting and sequencing of tasks based on real-time airplane configuration feed.

### Description of Related Art

Maintenance of complicated systems can involve a coordinated effort by a large group of technicians. For example, maintenance of a commercial aircraft can involve servicing numerous electrical and mechanical systems and can require the skills of technicians having different competencies. In some instances, servicing of these systems can happen in parallel. In other cases, servicing of particular systems cannot commence until servicing on other systems has been completed.

### SUMMARY

In a first aspect, a computer-implemented method includes receiving, by a computer and via a communication interface of an aircraft, current configuration information associated with the aircraft. The aircraft includes application logic configured to monitor a state associated with each of a plurality of components of the aircraft and to generate the current configuration information. The method further includes locating, by the computer, and in a maintenance task database, a particular maintenance task record that specifies configuration requirements that match the current configuration information of the aircraft. The configuration requirements specify one or more components of the plurality of components of the aircraft and the state within which each of the one or more components should be in to facilitate the performance of a maintenance task associated with the particular maintenance task record. The method includes responsive to locating the particular maintenance task record, communicating, by the computer, task information associated with the particular maintenance task record to a maintenance terminal, wherein the task information specifies the configuration requirements and the state of the one or more components specified in the configuration requirements.

In a second aspect, a system includes a memory and a processor. The memory stores instruction code. The processor is in communication with the memory. The instruction code is executable by the processor to cause the processor to perform operations that include receiving, via a communication interface of an aircraft, current configuration information associated with the aircraft. The aircraft includes application logic configured to monitor a state associated with each of a plurality of components of the aircraft and to generate the current configuration information. The processor locates, in a maintenance task database, a particular maintenance task record that specifies configuration requirements that match the current configuration information of the aircraft. The configuration requirements specify one or more components of the plurality of components of the aircraft and the state within which each of the one or more components should be in to facilitate the performance of a maintenance task associated with the particular maintenance task record. Responsive to locating the particular maintenance task record, the processor communicates task information associated with the particular maintenance task record to a maintenance terminal, wherein the task information specifies the configuration requirements and the state of the one or more components specified in the configuration requirements.

In a third aspect, a non-transitory computer-readable medium having stored thereon instruction code is provided. When the instruction code is executed by a processor, the processor performs operations that include receiving, via a communication interface of an aircraft, current configuration information associated with the aircraft. The aircraft includes application logic configured to monitor a state associated with each of a plurality of components of the aircraft and to generate the current configuration information. The processor locates, in a maintenance task database, a particular maintenance task record that specifies configuration requirements that match the current configuration information of the aircraft. The configuration requirements specify one or more components of the plurality of components of the aircraft and the state within which each of the one or more components should be in to facilitate the performance of a maintenance task associated with the particular maintenance task record. Responsive to locating the particular maintenance task record, the processor communicates task information associated with the particular maintenance task record to a maintenance terminal, wherein the task information specifies the configuration requirements and the state of the one or more components specified in the configuration requirements.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1 illustrates an environment that includes various systems/devices that facilitate maintenance scheduling, in accordance with an example.

FIG. 2A illustrates maintenance task records that can be stored in a maintenance database of a maintenance scheduling system (MSS) of the environment, in accordance with an example.

FIG. 2B illustrates additional fields of the maintenance task records, in accordance with an example.

FIG. 3 illustrates a user interface that can be generated by application logic of the MSS to facilitate communicating task information to a terminal, in accordance with an example.

FIG. 4 illustrates operations performed by the MSS when receiving initial configuration information of an aircraft., in accordance with an example.

FIG. 5 illustrates operations performed by the MSS when receiving updated configuration information from an aircraft, in accordance with an example.

FIG. 6 illustrates operations performed by the MSS to coordinate scheduling of tasks, in accordance with an example.

FIG. 7 illustrates another example of operations performed by the MSS when receiving updated configuration information from an aircraft, in accordance with an example

FIG. 8 illustrates a more detailed variation of the operations of FIGS. 4-7, in accordance with an example.

FIG. 9 illustrates a computer system that can form part of or implement any of the systems or devices of the environment, in accordance with an example.

### DETAILED DESCRIPTION

Implementations of this disclosure provide technological improvements that are particular to computer technology, for example, those related to scheduling maintenance for equipment having a large number of interrelated components. Computer-specific technological problems such as how to efficiently organize data in a database to facilitate scheduling maintenance on the equipment and how to communicate scheduling information to others in an efficient manner to facilitate performing the maintenance are overcome by the examples disclosed.

Some examples obviate these issues by associating maintenance tasks with specific of equipment configurations in a database. The database further specifies information that facilitates automatic routing of maintenance tasks to appropriate operators when the equipment is in a particular configuration. Automatic routing of the maintenance tasks can eliminate unnecessary communications with a scheduling system that would otherwise be required. This, in turn, can save power and resources of the scheduling system for other tasks.

Various examples of systems, devices, and/or methods are described herein. Words such as “example” and “exemplary” that may be used herein are understood to mean “serving as an example, instance, or illustration.” Any embodiment, implementation, and/or feature described herein as being an “example” or “exemplary” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, terms such as “substantially,” or “about” that may be used herein, are meant that the recited characteristic, parameter, or value need not be achieved exactly, but that deviations or variations, including, for example, tolerances, measurement error, measurement accuracy limitations and other factors known to skill in the art, may occur in amounts that do not preclude the effect the characteristic was intended to provide.

### I. Introduction

As noted above, maintenance of a complicated system such as a commercial aircraft can involve servicing numerous electrical and mechanical systems. Some maintenance tasks can be performed in parallel whereas others must be performed according to a sequence. In many instances, the different subsystems of the aircraft must be placed into a state that facilitates the performance of the maintenance task. For example, certain systems must be de-energized. Various hardware components (e.g., flaps, landing gear) may have to be placed into a particular configuration to facilitate the performance of the maintenance.

The systems and methods disclosed below facilitate the scheduling of maintenance tasks on equipment such as commercial aircraft. In general, the aircraft communicates a real-time feed of information to the system that specifies the state of various aspects of the aircraft. When the information indicates that the aircraft is in a particular configuration, the system searches a database for tasks that can be performed while the aircraft is in this configuration. The system communicates task information to maintenance terminals (e.g., portable/mobile terminals) that can be associated/carried by operators 105 to notify the operators 105 that the aircraft is in a state that facilitates the performance of these maintenance tasks. The information can also be communicated to legacy planning systems that may utilize/process the information for planning or production management purposes.

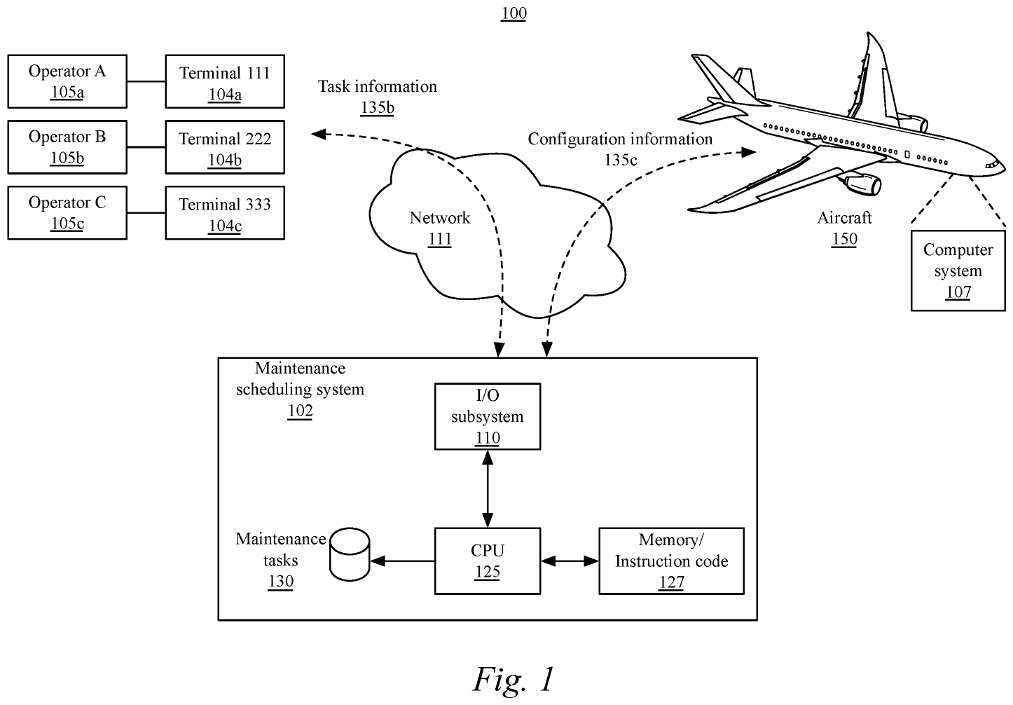

FIG. 1 illustrates an example of an environment 100 that includes various systems/devices that facilitate maintenance scheduling. Example systems/devices of the environment 100 include a maintenance scheduling system (MSS) 102, terminals 104, and an aircraft 150. The various entities of the environment 100 can be configured to communicate with one another via a network 112, such as the Internet.

An example of the aircraft 150 can include a computer system 107 that facilitates determining configuration aspects of the aircraft 150. Examples of the configuration aspects can specify the state of circuit breakers for enabling and disabling power to different components of the aircraft 150. The configuration aspects can specify the state of various subsystems, such as whether particular electrical subsystems and/or pumps are activated or deactivated. The configuration aspects can specify the state of particular hardware components, such as whether rudders, flaps, ailerons, landing gear, etc. are raised, centered, lowered, stowed, deployed, etc.

The computer system 107 can include a network interface that facilitates communicating configuration information 135c that specifies the configuration aspects of the aircraft 150 to the MSS 102. Some examples of the computer system 107 can be configured to communicate the configuration aspects in real-time. For example, the computer system 107 can communicate the configuration aspects in response to the actuation of a circuit breaker or actuation of other hardware of the aircraft 150 (e.g., lowering the flaps). The network interface can be wired or wireless.

An example of the maintenance scheduling system (MSS) 102 can correspond to a computer, mobile device, tablet, and/or any other device that facilitates user interactions. The MSS 102 can include a memory 127 and a processor 125. The MSS 102 can include other subsystems. Within examples, these subsystems can include an input/output (I/O) subsystem 110 and a maintenance task database 130. Details related to the various subsystems of the MSS 102 and the operations performed by these subsystems are described in further detail below.

The processor 125 is in communication with the memory 127. The processor 125 is configured to execute instruction code stored in the memory 127. The instruction code facilitates performing, by the MSS 102, various operations that facilitate maintenance scheduling. In this regard, the instruction code can cause the processor 125 to control and coordinate various activities performed by the different subsystems of the MSS 102. The processor 125 can correspond to a stand-alone computer system such as an Intel®, AMD®, or PowerPC® based computer system or a different computer system and can include application-specific computer systems. The computer system can include an operating system, such as Microsoft Windows®, Linux, Unix®, Apple IOS®, Android®, or a different operating system.

An example of the I/O subsystem 110 can include one or more input, output, or input/output interfaces and is configured to facilitate communications with entities outside of the MSS 102. For example, the I/O subsystem 110 can facilitate communications with the aircraft 150 and the terminals 104. In this regard, an example of the I/O subsystem 110 can be configured to dynamically determine the communication methodology utilized by entities of the environment 100 and can communicate information to the entities with an interface that uses a determined communication methodology. For example, the I/O subsystem 110 can determine that a first entity utilizes a RESTful API and can, therefore, communicate with the entity using an interface that uses a RESTful communication methodology.

An example of the I/O subsystem 110 can include a wireless interface that facilitates wirelessly communicating with entities of the environment 100. Within examples, the wireless interface can include an 802.11 based interface, a Bluetooth® interface, a cellular interface, a near field communication interface, and/or a different type of wireless interface. The cellular interface can be configured to implement various cellular telephone standards such a 3G, 4G, LTE, 5G, etc. It is contemplated that the cellular telephone standard could include and/or implement a yet to be developed wireless standard for communicating information between devices.

An example of the terminal 104 can correspond to a computer, mobile device, tablet, smartwatch and/or any other device that facilitates user interactions. The terminal 104 can include a memory and a processor. The terminal 104 can include other subsystems. Within examples, these subsystems can include an input/output (I/O) subsystem, a display, a keyboard, a mouse, etc.

It is contemplated that any of the subsystems referenced herein can correspond to a stand-alone computer system such as an Intel®, AMD®, or PowerPC® based computer system or a different computer system and can include application-specific computer systems. The computer systems can include an operating system, such as Microsoft Windows®, Linux, Unix®, or another operating system. It is also contemplated that operations performed on the various subsystems can be combined into a fewer or greater number of subsystems to facilitate speed scaling, cost reductions, etc.

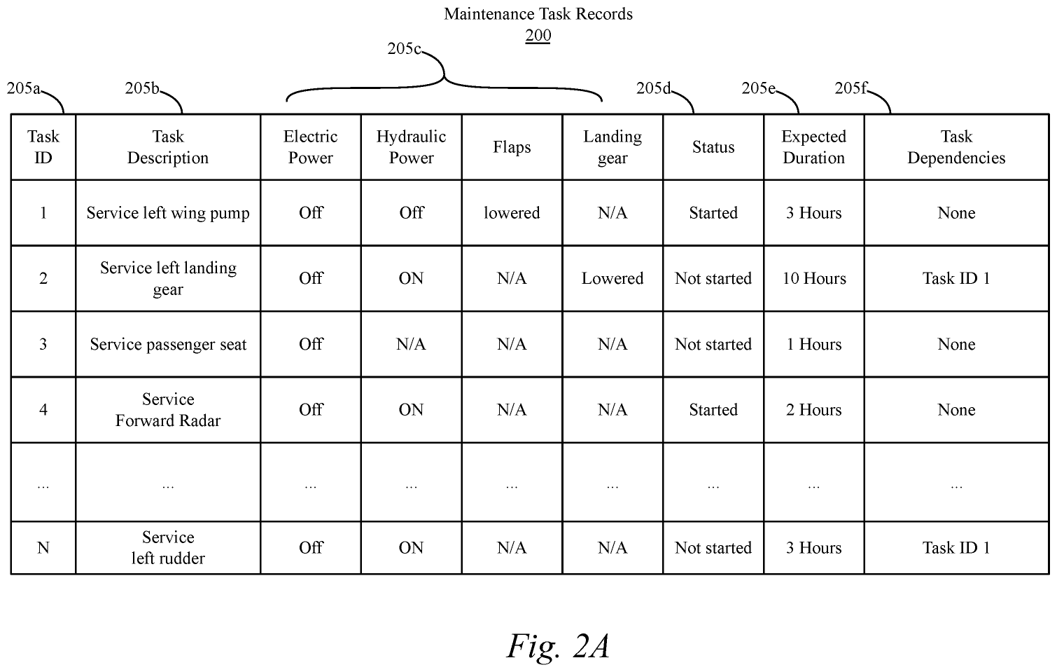

FIGS. 2A and 2B illustrate an example of maintenance task records 200 that can be stored in the maintenance task database 130. Within examples, fields 205 of each maintenance task record 200 can include a task ID field 205a, a task description field 205b, configuration requirement fields 205c, a task status field 205d, a task duration field 205e, task dependencies field 205f, a terminal ID field 205g, and an operator ID field 204h. Other information can be specified in the maintenance task records 200.

The task description field 205b of each maintenance task record 200 can specify a text that describes a particular maintenance task. For example, the task description associated with task ID 1 is “Service left-wing pump” to indicate that the task is associated with servicing a pump arranged in the left wing of an aircraft 150.

The configuration requirement fields 205c of each maintenance task record 200 represent the state a particular component or aspect of the aircraft 150 is required to be in to facilitate the performance of an associated task. Within examples, configuration requirement fields 205c can specify the state of electric power of the aircraft 150 or the state of a hydraulic pump as being on or off. Other configuration requirement fields 205c can specify the state of flaps and landing gear as being raised or lowered. Additional configuration requirement fields 205c for specifying the state of various circuit breakers (e.g., closed or opened), and for specifying the state of various panels (e.g., closed or opened) can be specified. In cases where a particular configuration requirement field 205c is not relevant to a particular task, the status for that configuration requirement fields can be specified as non-applicable (i.e., N/A). It should be understood that an actual aircraft can include a large number of systems and/or hardware and, therefore, that there can be a correspondingly large number of configuration requirement fields 205 specified in each maintenance task record 200.

The task status field 205d of each maintenance task record 200 specifies the progress of the task. For example, the task status field 205d for a particular task can specify whether the task is pending, started, completed, paused, etc.

The task duration field 205e of each maintenance task record 200 can specify the amount of time expected to perform the task. The amount of time can be specified in hours, days, weeks, etc.

The task dependencies field 205f of each maintenance task record 200 can specify whether the performance of a particular task is dependent on prior performance of another task. For example, as indicated in task IDs 2 and N, the performance of a task associated with the servicing of the left landing gear and the left rudder of the aircraft 150 may be dependent on the prior performance of task ID 1, which is associated with the servicing of the left-wing pump.

The terminal ID field 205g of each maintenance task record 200 can specify an ID that uniquely identifies a particular terminal 104 to which task information 135b can be communicated. The ID can correspond to information that facilitates communicating the task information 135b to the terminal 104. For example, the terminal ID field 205g can specify an IP address, a phone number, a URL, an email address, etc. associated with the terminal 104

The operator ID field 204h of each maintenance task record 200 can specify an operator 105 associated with a particular task. For example, the operator ID field 204h can specify the name of the operator 105, an employee ID associated with the operator 105, etc.

In some examples, the terminal ID field 205g and/or the operator ID field 205h for each maintenance task record 200 can initially be empty. An operator 105 from a pool of operators 105 may be assigned to particular tasks, and information that identifies the assigned operator 105 can be specified in the operator ID field 205h. Similarly, the terminal ID associated with the operator 105 can be specified in the terminal ID field 205g after the operator 105 has been assigned.

In some cases, operators 105 can be selected for a particular task based on various competencies of the operator 105. For example, an operator 105 certified in servicing electrical systems can be assigned to tasks related to electrical system servicing.

In some examples, an operator 105 can be given the option to perform a given task and can subsequently accept responsibility for performing the task. In this case, the terminal ID field 205g and/or the operator ID field 205h can be updated with the appropriate information after the operator 105 accepts responsibility for performing the task.

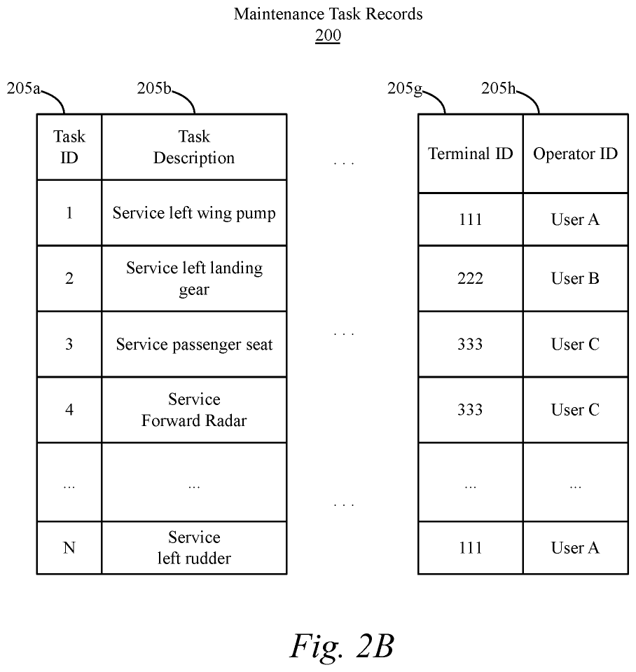

FIG. 3 illustrates an example of a user interface 300 that can be generated by application logic of the MSS 102 to facilitate communicating task information 135b to a terminal 104. Referring to FIG. 3, the user interface 300 can include one or more configuration aspect group controls 305, a description control 315, a status control 310, and an accept control 320.

The description control 315 can specify the description associated with a particular maintenance task. The description can correspond to the value of the task description field 205b for a particular maintenance task record 200.

The configuration aspect group controls 305 can include controls configured to indicate the configuration aspects of the aircraft 150 that are relevant (i.e., required) to the performance of the maintenance task. For example, a first configuration aspect group control 305a can include controls that specify the state associated with different circuit breakers of the aircraft 150. Each control can specify the name of the circuit breaker and the state (i.e., open or closed) of the circuit breaker.

A second configuration aspect group control 305b can include controls that specify the state associated with different hardware aspects of the aircraft 150. For example, a first control can specify whether the electrical power is on or off, a second control can specify whether the hydraulic power is on or off, a third control can specify whether the flaps are up or down, and/or a fourth control can specify whether the landing gear is up or down.

A third configuration aspect group control 305c can include controls that specify the state associated with different panels of the aircraft 150. For example, each control of the third configuration aspect group control 305c can specify whether a particular panel is opened or closed. One or more configuration aspect groups may be displayed depending on the type of airplane and the type of a task.

A status control 310 can indicate whether the various configuration aspects of the aircraft 150 are in respective states that facilitate the performance of the maintenance task. For example, the status control 310 can be colored green to indicate that the various configuration aspects of the aircraft 150 are in respective states that facilitate the performance of the maintenance task, or red to indicate that one or more of the configuration aspects are not in the correct state.

The accept control 320 can be actuated by an operator 105 of the terminal 104 to indicate acceptance by the operator 105 of the responsibility for performing the task specified in the description control 315. In this regard, some examples of the user interface 300 can present the operator 105 with options for selecting responsibility for performing one or more maintenance tasks. For example, the user interface can include one or more tab controls, and each tab control can further include a user interface similar to the user interface 300 depicted in the figure for specifying information associated with a particular maintenance task.

In operation, the MSS 102 can determine that a particular task is associated with a particular terminal 104 via the terminal ID field 205g of a maintenance task record 200. The MSS 102 can determine the configuration requirements associated with the task. The MSS 102 can configure the user interface 300 with controls associated with relevant configuration aspects (i.e., configuration aspects corresponding to configuration requirements). The MSS 102 can group the aspects according to the type of configuration aspect. For example, circuit breaker configuration aspects can be grouped in the first configuration aspect group control 305a, hardware configuration aspects can be grouped in the second configuration aspect group control 305b, and/or panel configuration aspects can be grouped in the third configuration aspect group control 305c.

The state of each configuration aspect can be specified by state indicators 312 of the configuration aspect group controls 305. In this regard, state indicators 312 can indicate two or more different states. For example, a state indicator 312 may be colored red to indicate that a particular configuration aspect is not in a state that facilitates the performance of the task or green to indicate that the configuration aspect is in the correct state. A different color can be used to specify that the configuration aspect is in an unknown state. Additional controls/states can be displayed to indicate whether particular configuration aspects required by other tasks are in progress or not. This can be used by the computer system 107 of the aircraft 150 to alter the configuration aspects as necessary.

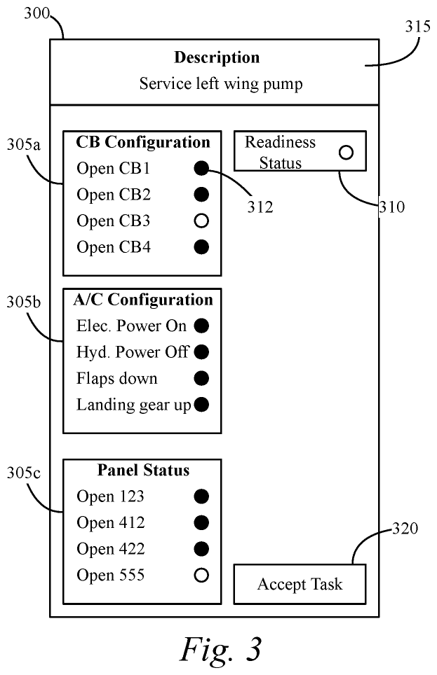

FIGS. 4-7 illustrate examples of operations performed by the MSS 102. In this regard, one or more of the operations can be implemented via instruction code, stored in the memory 127 of the MSS 102 configured to cause the processor 125 of the MSS 102 to perform the operations illustrated in the figures and discussed herein.

FIG. 4 illustrates operations performed by the MSS 102 when receiving initial configuration information 135c of an aircraft 150. Referring to FIG. 4, at operation 400, the MSS 102 can receive current configuration information 135c from the aircraft 150 that specifies configuration aspects of the aircraft 150. For example, the aircraft 150 can include a computer system 107 that facilitates determining configuration aspects of the aircraft 150. The configuration aspects can specify the state of various circuit breakers, subsystems, and hardware components of the aircraft 150. An example of the computer system 107 can be configured to communicate the configuration information 135c in real-time. For example, the computer system 107 can communicate the configuration information 135c in response to the actuation of a circuit breaker or actuation of other hardware of the aircraft 150. In other examples, the MSS 102 can request the configuration information 135c from the aircraft 150. For example, the MSS 102 can perform periodic polling of the aircraft 150 to request the configuration information 135c.

At operation 405, the MSS 102 can locate maintenance task records 200 in the maintenance task database 130 that match the current configuration information 135c from the aircraft 150. For example, the current configuration information 135c can specify that the electric power and the hydraulic power are off and that the flaps and the landing gear of the aircraft 150 are lowered. In this case, the MSS 102 can determine matching maintenance task records 200 that correspond to those associated with task IDs 1 and 3.

At operation 410, the MSS 102 can communicate task information 135b associated with the configuration aspects of the aircraft 150 to terminals 104 specified in the located maintenance task records 200. Following the example above, the MSS 102 can communicate the task information 135b to terminals 104 associated with IDs 111 and 333. The task information 135b can be communicated in the form of a user interface 300 that can be depicted on the terminal 104. Additionally, or alternatively, the task information 135b can be specified in a format such as XML, and the terminal 104 can generate a user interface 300 capable of depicting at least some of the configuration aspects specified in the task information 135b.

In some examples, the MSS 102 only communicates configuration aspects in the task information 135b that are relevant (i.e., required) to a particular task. For example, the states of the hydraulic power, flaps, and landing gear are not indicated in task ID 3 to be relevant to servicing the passenger seats. Therefore, the state of these aspects of the aircraft 150 may not be communicated to the corresponding terminal 104 (i.e., terminal 333).

At operation 415, the MSS 102 can receive an indication from the terminal 104 that the performance of the task has started. For example, an operator 105 of the terminal 104 may actuate a start control of the user interface 300 to indicate that the performance of the task has started.

At operation 420, the MSS 102 can update the task status field 205d of the maintenance task record 200 associated with the task accordingly.

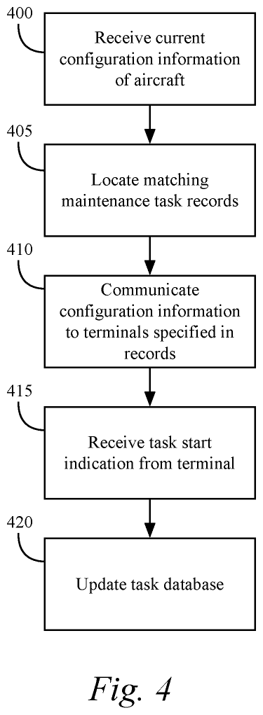

FIG. 5 illustrates operations performed by the MSS 102 when a configuration aspect of the aircraft 150 is changed. Referring to FIG. 5, at operation 500, the MSS 102 can receive updated configuration information 135c from the aircraft 150. For example, an operator 105 may have entered the aircraft 150 and actuated hydraulic power. Responsive to the actuation of the hydraulic power, the computer system 107 of the aircraft 150 can communicate updated configuration information 135c to the MSS 102.

At operation 505, the MSS 102 can determine whether the updated configuration information 135c affects any tasks that have been started. For example, the MSS 102 can determine that the task associated with task ID 1 is started because the corresponding status field is set to “Started.” This task requires hydraulic power to be off to facilitate servicing of a left-wing pump. Therefore, the MSS 102 can determine that the change in the configuration information 135c will affect this task.

At operation 510, the MSS 102 can communicate an alert to the terminal 104 associated with the task identified above. For example, the MSS 102 can communicate an updated user interface to the terminal 104 associated with Terminal ID 111. The updated user interface can be configured to draw the attention of the operator 105. For example, the updated user interface may flash between red and white, cause an audible alert, and/or provide haptic feedback to draw the attention of the operator 105. The updated user interface may alert the operator 105 to the particular configuration aspect that has changed. For example, the control of the user interface 300 associated with the configuration aspect may flash, change color, etc.

Responsive to receiving the alert, the operator 105 may then take steps to mitigate any issues that may arise from the continued performance of the task. For example, the operator 105 may cease the performance of the task until after the configuration aspect that caused the alert to be generated has reverted back to an acceptable state.

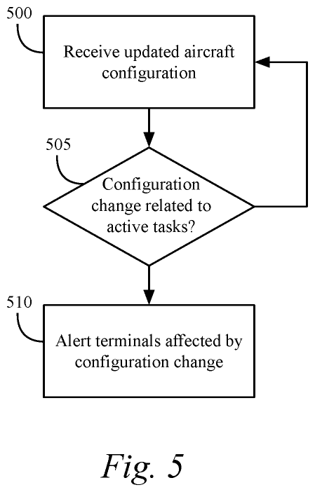

FIG. 6 illustrates operations performed by the MSS 102 to coordinate the scheduling of tasks. At operation 600, the MSS 102 can receive an indication that a first task has started. For example, the MSS 102 can receive an indication that the task associated with Task ID 111 has started.

At operation 605, the MSS 102 can determine whether any other tasks can be performed while the first task is being performed. In this regard, the MSS 102 can search the maintenance task records 200 for a) tasks having configuration requirements that are the same or a subset of the configuration requirements required for the performance of the first task, and b) that require equal or less time to perform. Following the example above, the MSS 102 can determine that the tasks associated with task IDs 3 and 4 can be performed simultaneously with the first task because a) both tasks have configuration requirements that are subsets of the configuration requirements for the first task (i.e., that the electric power be off and/or that the hydraulic power be on), and b) both require less time to perform (i.e., 1 and 2 hours, respectively).

At operation 610, the MSS 102 can communicate the configuration information 135c to terminals 104 associated with these task IDs. In some examples, this can involve determining an operator 105 with competencies that facilitate performing these tasks. Task information 135b (e.g., description and configuration aspects) associated with these tasks can be communicated to a terminal 104 associated with the operator 105. The operator 105 can subsequently agree to perform one or more of the tasks by, for example, selecting an accept control 320 of a user interface 300 presented on the terminal 104. After acceptance, the operator ID field 205h and the terminal ID field 205g for the maintenance task record 200 can be updated in the maintenance task database 130 to specify IDs associated with the operator 105 and the operator's terminal, respectively.

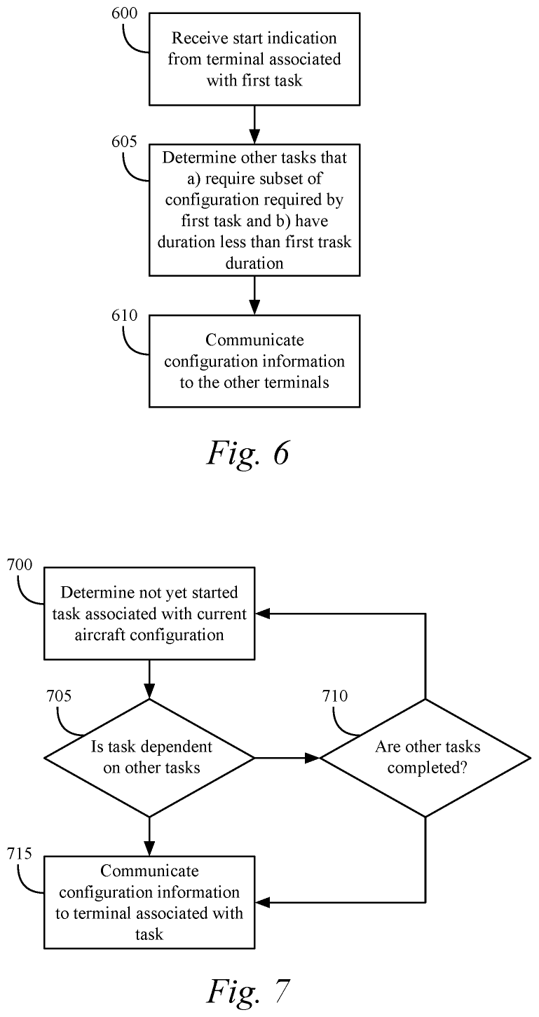

FIG. 7 illustrates another example of operations performed by the MSS 102 when receiving updated configuration information 135c of an aircraft 150. At operation 700, the MSS 102 can receive configuration information 135c from an aircraft 150 and determine that the configuration aspects specified in the configuration information 135c match configuration requirements associated with a particular maintenance task record 200. For example, the configuration information 135c may indicate that the electric power is off, the hydraulic power is on, and that the landing gear is lowered. In this case, the MSS 102 can determine that the configuration aspects of the configuration information 135c match configuration requirements of the maintenance task record 200 associated with task ID 2.

At operation 705, the MSS 102 can determine that the performance of the task determined above is dependent on the completion of a different task. For example, the MSS 102 can determine that the performance of the task is dependent on completion of the task associated with task ID 1, as specified by the task dependency field 205f of the maintenance task record 200.

If the task is dependent on another task, then at operation 710, the MSS 102 can determine whether the other task (i.e., task ID 1) has been completed. Following the example above, the MSS 102 can determine, based on the task status field 205d of the other task, that the other task has not yet completed. In this case, the operations can continue from operation 700.

If the task is not dependent on other tasks or the other tasks have been completed, then at operation 715, the MSS 102 can communicate task information 135b associated with the maintenance task record 200 to a terminal 104.

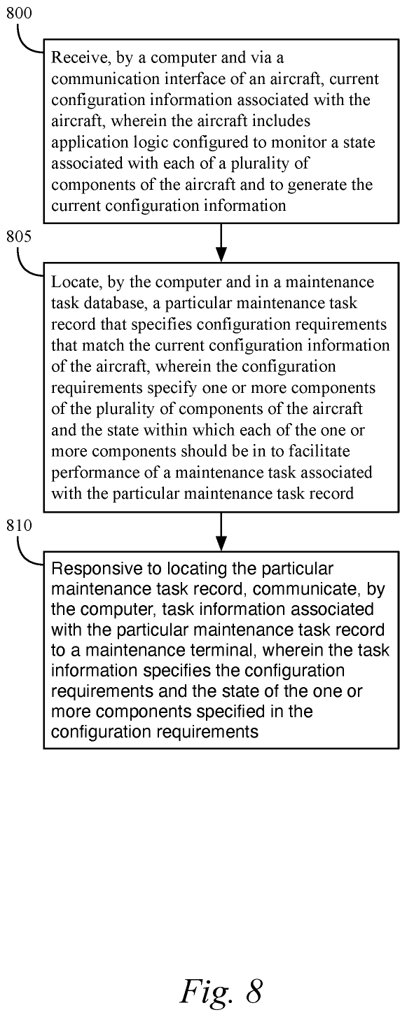

FIG. 8 illustrates an example of a more detailed variation of the operations of FIGS. 4-7. Block 800 can involve receiving, by a computer, and via a communication interface of an aircraft 150, current configuration information 135c associated with the aircraft 150. The aircraft 150 can include application logic configured to monitor a state associated with each of a plurality of components of the aircraft 150 and to generate the current configuration information 135c.

Block 805 can involve locating, by the computer, and in a maintenance task database 130, a particular maintenance task record 200 that specifies configuration requirements that match the current configuration information 135c of the aircraft 150. The configuration requirements can specify one or more components of the plurality of components of the aircraft 150 and the state within which each of the one or more components should be in to facilitate the performance of a maintenance task associated with the particular maintenance task record 200.

Block 810 can involve, responsive to locating the particular maintenance task record 200, communicating, by the computer, task information 135b associated with the particular maintenance task record 200 to a maintenance terminal 104. The task information 135b can specify the configuration requirements and the state of the one or more components specified in the configuration requirements.

Some examples can involve subsequently receiving, by the computer and from the application logic of the aircraft 150, second configuration information 135c associated with the aircraft 150, determining, by the computer, whether a current state associated with at least one component of the one or more components specified in the configuration requirements of the particular maintenance task record 200 is different from a previous state of the at least one component; and responsive to determining that the current state is different from the previous state, communicating, by the computer, an alert to the maintenance terminal 104 to notify an operator 105 that the aircraft 150 is not in a configuration that facilitates performance of the maintenance task associated with the particular maintenance task record 200.

Some examples can involve receiving, by the computer and from the maintenance terminal 104, a maintenance start indication, updating, by the computer and in the maintenance task database 130, the particular maintenance task record 200 to specify that maintenance has started, and communicating, by the computer and to the application logic, and indication to maintain the state of the one or more components specified in the configuration requirements of the particular maintenance task record 200.

In some examples, the particular maintenance task record 200 specifies a maintenance time that corresponds to an amount of time required to perform the associated maintenance task. These examples can involve locating, by the computer and in the maintenance task database 130, other maintenance task records 200 that specify configuration requirements that correspond to subsets of the configuration requirements associated with the particular maintenance task record 200 and that specify a maintenance time that is less than the maintenance time specified in the particular maintenance task record 200, and responsive to locating the other maintenance task records 200, communicating, by the computer, task information 135b associated with the other maintenance task records 200 to other maintenance terminals 104 to facilitate simultaneous performance of maintenance tasks associated with the particular maintenance task record 200 and the other maintenance task records 200.

In some examples, receiving current configuration information 135c associated with the aircraft 150 can involve receiving, by the computer, the current configuration information 135c in substantially real-time, wherein the application logic is configured to push the current configuration information 135c to the computer responsive to detection by the application logic of a change in the state of a component of the plurality of components.

In some examples, the particular maintenance task record 200 specifies maintenance task dependencies. In these cases, locating the particular maintenance task record 200 can involve determining, by the computer, a completion status of the maintenance task dependencies from dependency maintenance task records 200 associated with the maintenance task dependencies, and communicating, by the computer, task information 135b to the maintenance terminal 104 that further specifies the completion status of the maintenance task dependencies

In some examples, communicating the task information 135b to the maintenance terminal 104 can involve configuring, by the computer, a user interface 300 for display on the maintenance terminal 104 that graphically depicts the state of each of the one or more components specified in the configuration requirements.

Some examples can involve configuring, by the computer, the user interface 300 to depict the one or more components as belonging to component groups, wherein the component groups include one or more of: a circuit breaker group, a hardware configuration group, a panel status group, and a system group.

Some examples can involve configuring, by the computer, the user interface 300 to depict a task readiness indicator that indicates whether all of the one or more components are in a state that facilitates the performance of the maintenance task.

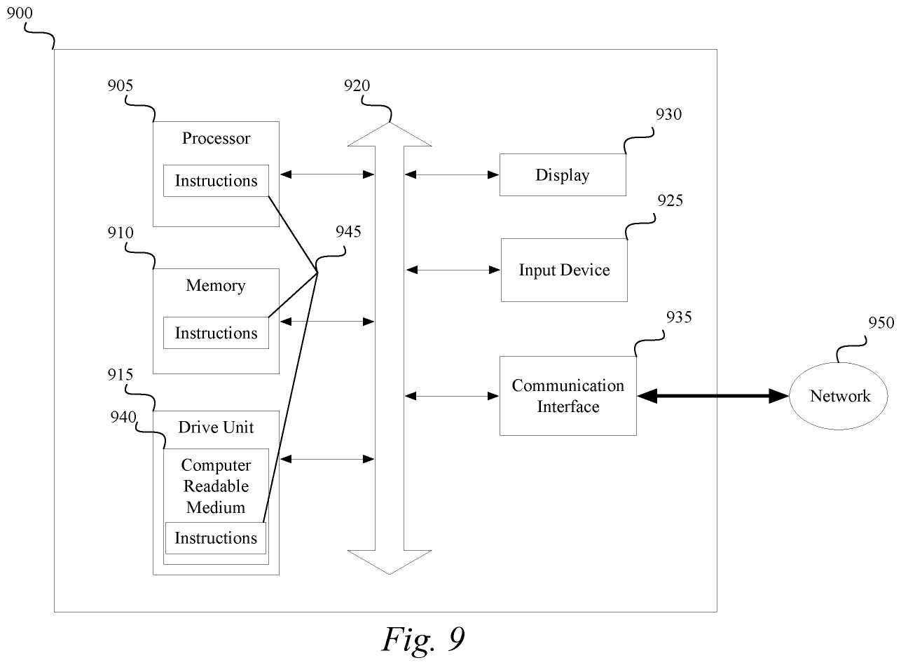

FIG. 9 illustrates an example of a computer system 900 that can form part of or implement any of the systems and/or devices described above. The computer system 900 can include a set of instructions 945 that the processor 905 can execute to cause the computer system 900 to perform any of the operations described above. An example of the computer system 900 can operate as a stand-alone device or can be connected, e.g., using a network, to other computer systems or peripheral devices.

In a networked example, the computer system 900 can operate in the capacity of a server or as a client computer in a server-client network environment, or as a peer computer system in a peer-to-peer (or distributed) environment. The computer system 900 can also be implemented as or incorporated into various devices, such as a personal computer or a mobile device, capable of executing instructions 945 (sequential or otherwise), causing a device to perform one or more actions. Further, each of the systems described can include a collection of subsystems that individually or jointly execute a set, or multiple sets, of instructions to perform one or more computer operations.

The computer system 900 can include one or more memory devices 910 communicatively coupled to a bus 920 for communicating information. In addition, code operable to cause the computer system to perform operations described above can be stored in the memory 910. The memory 910 can be random-access memory, read-only memory, programmable memory, hard disk drive, or any other type of memory or storage device.

The computer system 900 can include a display 930, such as a liquid crystal display (LCD), a cathode ray tube (CRT), or any other display suitable for conveying information. The display 930 can act as an interface for the user to see processing results produced by processor 905.

Additionally, the computer system 900 can include an input device 925, such as a keyboard or mouse or touchscreen, configured to allow a user to interact with components of system 900.

The computer system 900 can also include a disk or optical drive unit 915. The drive unit 915 can include a computer-readable medium 940 in which the instructions 945 can be stored. The instructions 945 can reside completely, or at least partially, within the memory 910 and/or within the processor 905 during execution by the computer system 900. The memory 910 and the processor 905 also can include computer-readable media as discussed above.

The computer system 900 can include a communication interface 935 to support communications via a network 950. The network 950 can include wired networks, wireless networks, or combinations thereof. The communication interface 935 can enable communications via any number of communication standards, such as 802.11, 802.12, 802.20, WiMAX, cellular telephone standards, or other communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

1. A computer-implemented method comprising:
receiving, by a computer and via a communication interface of an aircraft, current configuration information associated with the aircraft, wherein the aircraft includes application logic configured to monitor a state associated with each of a plurality of components of the aircraft and to generate the current configuration information;
locating, by the computer and in a maintenance task database, a particular maintenance task record that specifies configuration requirements that match the current configuration information of the aircraft, wherein the configuration requirements specify one or more components of the plurality of components of the aircraft and the state within which each of the one or more components should be in to facilitate performance of a maintenance task associated with the particular maintenance task record; and
responsive to locating the particular maintenance task record, communicating, by the computer, task information associated with the particular maintenance task record to a maintenance terminal, wherein the task information specifies the configuration requirements and the state of the one or more components specified in the configuration requirements.

2. The computer-implemented method according to claim 1, further comprising:
subsequently receiving, by the computer and from the application logic of the aircraft, second configuration information associated with the aircraft;
determining, by the computer, whether a current state associated with at least one component of the one or more components specified in the configuration requirements of the particular maintenance task record is different from a previous state of the at least one component; and
responsive to determining that the current state is different from the previous state, communicating, by the computer, an alert to the maintenance terminal to notify an operator that the aircraft is not in a configuration that facilitates performance of the maintenance task associated with the particular maintenance task record.

3. The computer-implemented method according to claim 1, further comprising:
receiving, by the computer and from the maintenance terminal, a maintenance start indication;
updating, by the computer and in the maintenance task database, the particular maintenance task record to specify that maintenance has started; and
communicating, by the computer and to the application logic, and indication to maintain the state of the one or more components specified in the configuration requirements of the particular maintenance task record.

4. The computer-implemented method according to claim 1, wherein the particular maintenance task record specifies a maintenance time that corresponds to an amount of time required to perform the associated maintenance task, wherein the method further comprises:
locating, by the computer and in the maintenance task database, other maintenance task records that specify configuration requirements that correspond to subsets of the configuration requirements associated with the particular maintenance task record and that specify a maintenance time that is less than the maintenance time specified in the particular maintenance task record; and
responsive to locating the other maintenance task records, communicating, by the computer, task information associated with the other maintenance task records to other maintenance terminals to facilitate simultaneous performance of maintenance tasks associated with the particular maintenance task record and the other maintenance task records.

5. The computer-implemented method according to claim 1, wherein receiving current configuration information associated with the aircraft further comprises:
receiving, by the computer, the current configuration information in substantially real-time, wherein the application logic is configured to push the current configuration information to the computer responsive to detection by the application logic of a change in the state of a component of the plurality of components.

6. The computer-implemented method according to claim 1, wherein the particular maintenance task record specifies maintenance task dependencies, wherein locating the particular maintenance task record further comprises:
determining, by the computer, a completion status of the maintenance task dependencies from dependency maintenance task records associated with the maintenance task dependencies; and
communicating, by the computer, task information to the maintenance terminal that further specifies the completion status of the maintenance task dependencies.

7. The computer-implemented method according to claim 1, wherein communicating the task information to the maintenance terminal further comprises:
configuring, by the computer, a user interface for display on the maintenance terminal that graphically depicts the state of each of the one or more components specified in the configuration requirements.

8. The computer-implemented method according to claim 7, further comprising:
configuring, by the computer, the user interface to depict the one or more components as belonging to component groups, wherein the component groups include one or more of: a circuit breaker group, a hardware configuration group, a panel status group, and a system group.

9. The computer-implemented method according to claim 8, further comprising:
configuring, by the computer, the user interface to depict a task readiness indicator that indicates whether all of the one or more components are in a state that facilitates performance of the maintenance task.

10. A system comprising:
a memory that stores instruction code; and
a processor in communication with the memory, wherein the instruction code is executable by the processor to perform operations comprising:
receiving, via a communication interface of an aircraft, current configuration information associated with the aircraft, wherein the aircraft includes application logic configured to monitor a state associated with each of a plurality of components of the aircraft and to generate the current configuration information;
locating, in a maintenance task database, a particular maintenance task record that specifies configuration requirements that match the current configuration information of the aircraft, wherein the configuration requirements specify one or more components of the plurality of components of the aircraft and the state within which each of the one or more components should be in to facilitate performance of a maintenance task associated with the particular maintenance task record; and
responsive to locating the particular maintenance task record, communicating task information associated with the particular maintenance task record to a maintenance terminal, wherein the task information specifies the configuration requirements and the state of the one or more components specified in the configuration requirements.

11. The system according to claim 10, wherein the instruction code is executable by the processor to perform further operations comprising:
subsequently receiving, from the application logic of the aircraft, second configuration information associated with the aircraft;
determining whether a current state associated with at least one component of the one or more components specified in the configuration requirements of the particular maintenance task record is different from a previous state of the at least one component; and
responsive to determining that the current state is different from the previous state, communicating an alert to the maintenance terminal to notify an operator that the aircraft is not in a configuration that facilitates performance of the maintenance task associated with the particular maintenance task record.

12. The system according to claim 10, wherein the instruction code is executable by the processor to perform further operations comprising:
receiving from the maintenance terminal, a maintenance start indication;
updating, in the maintenance task database, the particular maintenance task record to specify that maintenance has started; and
communicating, to the application logic, and indication to maintain the state of the one or more components specified in the configuration requirements of the particular maintenance task record.

13. The system according to claim 10, wherein the particular maintenance task record specifies a maintenance time that corresponds to an amount of time required to perform the associated maintenance task, wherein the instruction code is executable by the processor to perform further operations comprising:
locating, in the maintenance task database, other maintenance task records that specify configuration requirements that correspond to subsets of the configuration requirements associated with the particular maintenance task record and that specify a maintenance time that is less than the maintenance time specified in the particular maintenance task record; and
responsive to locating the other maintenance task records, communicating task information associated with the other maintenance task records to other maintenance terminals to facilitate simultaneous performance of maintenance tasks associated with the particular maintenance task record and the other maintenance task records.

14. The system according to claim 10, wherein in receiving current configuration information associated with the aircraft, the instruction code is executable by the processor to perform further operations comprising:
receiving the current configuration information in substantially real-time, wherein the application logic is configured to push the current configuration information to the system responsive to detection by the application logic of a change in the state of a component of the plurality of components.

15. The system according to claim 10, wherein the particular maintenance task record specifies maintenance task dependencies, wherein in locating the particular maintenance task record, the instruction code is executable by the processor to perform further operations comprising:
determining a completion status of the maintenance task dependencies from dependency maintenance task records associated with the maintenance task dependencies; and
communicating task information to the maintenance terminal that further specifies the completion status of the maintenance task dependencies.

16. The system according to claim 10, wherein in communicating the task information to the maintenance terminal, the instruction code is executable by the processor to perform further operations comprising:
configuring a user interface for display on the maintenance terminal that graphically depicts the state of each of the one or more components specified in the configuration requirements.

17. The system according to claim 16, wherein the instruction code is executable by the processor to perform further operations comprising:
configuring the user interface to depict the one or more components as belonging to component groups, wherein the component groups include one or more of: a circuit breaker group, a hardware configuration group, a panel status group, and a system group.

18. The system according to claim 17, wherein the instruction code is executable by the processor to perform further operations comprising:
configuring the user interface to depict a task readiness indicator that indicates whether all of the one or more components are in a state that facilitates performance of the maintenance task.

19. A non-transitory computer-readable medium having stored thereon instruction code, wherein the instruction code is executable by a processor of a computer to perform operations comprising:
receiving, via a communication interface of an aircraft, current configuration information associated with the aircraft, wherein the aircraft includes application logic configured to monitor a state associated with each of a plurality of components of the aircraft and to generate the current configuration information;
locating, in a maintenance task database, a particular maintenance task record that specifies configuration requirements that match the current configuration information of the aircraft, wherein the configuration requirements specify one or more components of the plurality of components of the aircraft and the state within which each of the one or more components should be in to facilitate performance of a maintenance task associated with the particular maintenance task record; and
responsive to locating the particular maintenance task record, communicating task information associated with the particular maintenance task record to a maintenance terminal, wherein the task information specifies the configuration requirements and the state of the one or more components specified in the configuration requirements.

20. The non-transitory computer-readable medium according to claim 19, wherein the instruction code is executable by the processor of the computer to perform further operations comprising:
subsequently receiving, from the application logic of the aircraft, second configuration information associated with the aircraft;
determining whether a current state associated with at least one component of the one or more components specified in the configuration requirements of the particular maintenance task record is different from a previous state of the at least one component; and
responsive to determining that the current state is different from the previous state, communicating an alert to the maintenance terminal to notify an operator that the aircraft is not in a configuration that facilitates performance of the maintenance task associated with the particular maintenance task record.
